(19) United States
(12) Patent Application Publication
(10) Pub. No.: US 2004/0229058 A1
(43) Pub. Date: Nov. 18, 2004

(54) Multilayer film

(76) Inventor: Yves M. Trouilhet, Vesenaz (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/842,172

(22) Filed: May 10, 2004

Related U.S. Application Data
(60) Provisional application No. 60/470,378, filed on May 12, 2003.

(51) Int. Cl. G03C 1/825

(52) U.S. Cl. 428/476.3; 428/500

(57) ABSTRACT

The present invention relates to a multilayer film comprising in the following sequence:

a) at least one substrate film layer comprising an axially oriented polyamide film; and

b) at least one solvent free polymeric film layer comprising a grafted polypropylene and extrusion coated on the substrate film layer of a).

The multilayer film according to the present invention is particularly suitable for medicaments and food packaging. It is well retortable and it is manufactured using solvent free components.

This application claims the benefit of U.S. Provisional Application No. 60/470,378, filed May 12, 2003 and is incorporated by reference herein for all purpose as if fully set forth.

### FIELD OF INVENTION

The present invention relates to a flexible, retortable multilayer material suitable, inter alia, as packaging for medicaments and food.

### BACKGROUND OF THE INVENTION

For certain applications, it is desirable to have flexible packaging which can be retorted. This is for instance the case in the pharmaceutical and food industry where the packaged goods often undergo sterilization treatments.

To date, one of the methods for producing retortable structures is limited to adhesive laminations combining an external layer made of polyester or polyamide with an interior layer made of e.g. polypropylene or of an aluminum foil. The manufacture of such retortable structures, however, involves the use of tie materials which contain an important amount of solvents such as methyl-ethyl ketone, toluene and acetaldehyde.

The use of tie materials including solvents leads to two major problems. It is first necessary to implement a recovery system for capturing the solvent emissions during the manufacture of the multilayer film structures. Such a system is often not efficient and is relatively complicated, thus rendering the overall film manufacturing process expensive and not respectful of the environment. It is furthermore difficult to completely remove the solvent from the tie material once the multilayer film is produced. The solvent residues migrate to the internal layers of the structure and might eventually contaminate the packaging content.

Polyamide multilayer films manufactured using solvent free tie materials are known in the art. However, such films are manufactured by cast or blown film co-extrusion of the polyamide with e.g. a polypropylene and the solvent free tie material. The polyamide is co-extruded in form of a melt, so that it cannot be axially oriented prior to the manufacturing process. The multilayer film material so obtained does not exhibit the desired mechanical and gas barrier properties. In fact, if axially oriented, a polyamide structure can increase both its mechanical properties and gas barrier capacity up to 1.5 times, if mono-axially oriented, and up to 3 times if bi-axially oriented. Excellent mechanical properties, such as the tear resistance, and barrier properties against oxygen and moisture are essential features for a packaging material to preserve the integrity of goods like food and pharmaceuticals over a long period of time.

Therefore, there is still a need for a retortable, solvent free multilayer packaging material having good mechanical and gas barrier properties.

### SUMMARY OF THE INVENTION

Now, it has been surprisingly found that the above mentioned problems can be overcome by extrusion coating an axially oriented polyamide film with a solvent free polymeric material.

An aspect of the invention is a multilayer film for flexible packaging comprising in the following sequence:

a) at least one substrate film layer comprising an axially oriented polyamide film; and

b) at least one solvent free polymeric film layer comprising a grafted polypropylene that is extrusion coated on the substrate film layer of a).

The multilayer film according to the present invention is manufactured using solvent free components. It is therefore environment friendly and its manufacture does not need the use of complex systems for capturing solvent emissions. The multilayer structure according to the present invention also shows good organoleptic properties.

The multilayer film according to the present invention is a good barrier to oxygen and water vapor and shows good mechanical properties. It shows a good tear and perforation resistance, a good stiffness and a nice gloss.

The multilayer film according to the present invention keeps its excellent mechanical and gas barrier properties, as well an excellent adhesion between the different layers, even after retort. Packaged pharmaceuticals and food often undergo retort at temperatures up to 130° C. and for periods of time of thirty (30) minutes or more. It is therefore essential that, during such processes, the packaging material does not alter its physical and/or chemical properties.

An additional aspect of the present invention is a flexible packaging having at least one component comprising the multilayer film described above. The flexible packaging according to the present invention can be used as pharmaceuticals and/or food packaging.

### DETAILED DESCRIPTION OF THE INVENTION

The substrate film layer is made of an axially oriented polyamide film and has a thickness preferably ranging from about 10 to about 40 μm and, still more preferably, from about 15 to about 30 μm. Any axially oriented polyamide available on the market is suitable for the purpose of the present invention, like for example a polyamide 6 or polyamide 6.6. The polyamide film used according to the present invention is preferably bi-axially oriented but mono-axially oriented films may also be used. The substrate film layer is a barrier against oxygen. Preferably, the barrier layer has a transmission rate of less than 100 cm³/(m²·24 h), preferably of less than 50 cm³/(m²·24 h), measured according to ASTM D-1435-66 at a temperature of 23° C. and a relative humidity of 0%.

The substrate film layer may also comprise an axially oriented polyamide in form of a multilayer film structure in order to further increase one or more of its physical and/or chemical features. For example, the barrier to oxygen provided by the substrate film layer can be increased if an axially oriented multilayer structure “polyamide//ethylene vinyl alcohol (EVOH)//polyamide” is used instead of a single axially oriented polyamide layer.

An axially bi-oriented polyamide suitable for the purposes of the present invention is obtainable, for example, from the company SNIA Tecnopolimeri S.p.A, Italy under the trade name Filmon® BX.

The solvent free polymeric film layer of the multilayer film according to the present invention is co-extrusion coated on the substrate film layer. The solvent free polymeric film layer is a co-extrudable adhesive based on polypropylene in form of a homopolymer or in form of a propylene/ethylene copolymer. If propylene/ethylene copolymers are used, the ethylene monomer is preferably present in the copolymer in an amount ranging from about 2 to about 8%, relative to the total weight of the copolymer. According to a preferred embodiment of the present invention, the solvent free polymeric film layer is modified (grafted) with maleic anhydride which is preferably present in the solvent free polymeric film layer in an amount ranging from about 0.1 to about 1.5% of the total weight of the solvent free polymeric film layer and, still more preferably, in an amount of about 1% of the total weight of the solvent free polymeric film layer.

The solvent free polymeric film layer has a sealant function, serves as a barrier against moisture and it is in contact with the packaged goods. This means that it is directed to the goods by touching them or not, depending on the specific circumstances.

The solvent free polymeric film layer has a thickness ranging from about 3 to about 50 μm, still more preferably from about 5 to about 15 μm. It must have a melting temperature which is low enough for enabling an easy sealability, but which is high enough to allow retort. Suitable melting temperatures range from about 130 to about 165° C., still more preferably from about 140 to about 155° C. Suitable melt flow index values preferably range from about 3 to about 50 dg/min, still more preferably from about 5 to about 10 dg/min, the melt flow index being measured according to ASTM D1238 at 230° C. and 2.16 kg.

Maleic anhydride modified polypropylenes suitable for the solvent free polymeric film layer described above are commercially available under the trade names Bynel® Series 5000, from E. I. du Pont de Nemours and Company of Wilmington, Del., U.S.A.

According to a preferred embodiment of the present invention, a water borne extrusion primer layer is applied between the substrate film layer and the solvent free polymeric film layer. The primer layer has a thickness which is preferably less than 1 μm. If such a primer is used, an excellent adhesion between the substrate and the solvent free polymeric film layer is provided so that a thermal treatment of the multilayer film after the co-extrusion process is no longer necessary. In this case the substrate film layer is first e.g. corona treated to provide increased active adhesive sites thereon, thereby promoting primer adhesion. The primer is then applied to the corona treated substrate film layer by conventional solution coating means. Primer materials which are suitable for the purpose of the present invention are well known in the art and include, for example, titanates and poly(ethylene imine). A particular effective primer herein is poly(ethylene imine) applied as either an aqueous or organic solvent solution, e.g. of ethanol, containing the imine at a concentration of about 5% of the total weight of the solution. A primer suitable for the present invention is commercially available under the trade name MICA® A-131-X from Mica Corporation, Connecticut, U.S.A.

According to a preferred embodiment, the multilayer film of the present invention further comprises at least one functional layer adjacent to the solvent free polymeric film layer on the opposite side of the substrate film layer. In this preferred embodiment, the solvent free polymeric film layer assumes the role of a tie layer between the substrate film layer and the functional layer. The functional layer can be made of any kind of material which can further strengthen the chemical and/or physical properties of the multilayer film structure and/or confer to the multilayer film structure additional chemical and/or physical properties.

According to a preferred embodiment of the present invention, the functional layer is preferably a sealant layer in contact with the packaged goods. By using a sealant layer, the thickness of the solvent free polymeric layer can be reduced, thus enabling a reduction in the overall costs of the multilayer film structure according to the present invention.

The sealant layer is preferably based on polypropylene in form of a homopolymer or in form of a propylene/ethylene copolymer. If propylene/ethylene copolymers are used, the ethylene monomer is preferably present in the copolymer in an amount ranging from about 2 to about 8%, relative to the total weight of the copolymer. The polypropylene based material used for the sealant layer may be the same of that used for the solvent free polymeric film layer described above. It may also be different, e.g. in the ethylene content, in order to have different properties like the melting temperature and/or the melt flow index. The sealant layer also serves as a barrier against moisture.

The sealant layer preferably has a thickness ranging from about 3 to about 50 μm, still more preferably from about 10 to about 40 μm. The sealant layer must have a melting temperature which is low enough for enabling an easy sealability, but which is high enough to allow retort. Suitable melting temperatures range from about 140° C. to about 155° C. Suitable melt flow index values for the polypropylene based material usable as the sealant layer range from about 3 to about 50 dg/min, and more preferably from about 5 to about 10 dg/min, the melt flow index being measured according to ASTM D1238 at 230° C. and 2.16 kg.

The multilayer film according to the present invention comprising a sealant layer as described above is highly transparent due to the nature of the various polymers included in its structure. As such it is invisible to the customer, thus providing more visual appeal to the overall packaging and facilitating quality assurance of its contents. Furthermore, thanks to its low coefficient of friction, such a multilayer film can be processed at high speed in packaging machines.

According to another preferred embodiment of the present invention, the functional layer is a metal based foil, free of residual oil and suitable for extrusion coating. Preferably, such foil has a thickness ranging from about 6 to about 100 μm and, still more preferably, from about 9 to about 50 μm. The foil can be based on any suitable metal and/or metal alloy such as aluminum, copper and steel. Preferably, the foil is essentially made of aluminum.

Each of the layers mentioned above may comprise the usual additives including plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, for example release agents, and/or mixtures thereof. The antioxidants may be present in an amount of about 400 to about 500 ppm in a layer.

The total thickness of the multilayer film according to the present invention ranges preferably from about 15 μm to about 500 μm, and more preferably from about 30 μm to about 100 μm.

Another aspect of the present invention is a flexible packaging having at least one component comprising a multilayer film according to the invention. According to a preferred embodiment, the flexible packaging can include one or more lids made with the multilayer film of the invention. Due to the physical properties of the multilayer film of the invention, a lid made thereof is well retortable, which helps to maintain the mechanical and/or chemical properties of the overall packaging after thermal treatment. Alternatively, the flexible packaging can be entirely made with the multilayer film of the invention. Examples thereof are lidded trays and pouches.

The multilayer film according to the present invention may be prepared by extrusion coating the substrate film layer with the solvent free polymeric film.

The multilayer film according to the present invention may be prepared by extrusion coating as follows: The solvent free polymeric material in pellet form is conveyed in the hopper of the extruder. The extruder melts the solvent free polymeric material and develops a certain pressure to force it through a flat die. The melt curtain leaving the die is drawn by two rolls forming the nip: a chill-roll and a rubber coated roll. In the nip, the solvent free polymeric material is pressed on the substrate film layer which is unwound from a roll, to develop adhesion. It is then cooled by the chill-roll and solidified. The substrate film layer can be flame treated, corona treated or primed before entering the nip where it is coated by the melt curtain. The typical line speed is between about 100 and about 300 m/min. If an additional polymeric layer, such as a sealant layer, is added as functional layer, it can be co-extruded with the solvent free polymeric material through the same die to the substrate film layer. If a metal based foil, such as an aluminum foil, is used as a functional layer, it can be unwound from a second roll and extrusion laminated with the solvent free polymeric film layer to the substrate film layer. Such a metal based foil can be previously flame or corona treated, if necessary.

Through extrusion, co-extrusion or lamination coating, the multilayer film of the present invention can be made in one single operation, at high speed and at low cost.

The invention will be further described in the following Examples whereas the substrate film layer is always indicated in the first place and separated from the co-extruded layers by //.

### EXAMPLE

Description of Ingredients:

Materials used in the Example set forth below are as follows, identified by the respective trademarks and trade designations:

### Materials for Samples According to the Invention

Substrate film layer-1(boPA): bi-axially oriented polyamide film, thickness: 25 μm, commercially available from SNIA Tecnopolimeri S.p.A under the trade name Filmon® BX.

Primer-1: MICA® A-131-X, diluted with water 1:1, commercially available from Mica Corporation.

Primer-2: MICA® H-760, diluted with water 1:3.5, commercially available from Mica Corporation.

Solvent Free Polymeric Film Layer-1 (Tie-1): Bynel® 50E739, commercially available from E. I. du Pont de Nemours and Company.

Solvent Free Polymeric Film Layer-2 (Tie-2): 85 wt % Bynel® 50E739+15 wt % Fusabond® MD353D. Fusabond® MD353D is commercially available from E. I. du Pont de Nemours and Company.

Solvent Free Polymeric Film Layer-3 (Tie-3): Bynel® XB604-5, commercially available from E. I. du Pont de Nemours and Company.

Sealant Layer (PPx): Polypropylene grade RD204CF, commercially available from Borealis OY.

Al-Foil: Aluminum 45 μm for blisters commercially available from Lawson Mardon Singen GmbH.

### Materials for Comparative Samples

Substrate film layer-2(boPET): bi-axially oriented polyester film, thickness: 23 μm, commercially available from E. I. du Pont de Nemours and Company under the trade name Mylar® 23A.

The following multilayer film samples according to the present invention were prepared (the primer layer thickness was always below 1 μm):

Sample 1: boPA (25 μm) // Primer-1 // Tie-1 (5 μm)/PPx (35 μm)

Sample 2: boPA (25 μm) // Primer-1 // Tie-2 (5 μm)/PPx (35 μm)

Sample 3: boPA (25 μm) // Primer-2 // Tie-1 (5 μm)/PPx (35 μm)

Sample 4: boPA (25 μm) // Primer-2 // Tie-2 (5 μm)/PPx (35 μm)

Sample 5: boPA (25 μm) // Primer-1 // Tie-3 (12 μm) // Al-Foil (45 μm)

Sample 6: boPA (25 μm) // Tie-3 (10 μm) // Al-Foil (45 μm)

The following comparative multilayer film samples were prepared (Comp.):

Sample 7: boPET (25 μm) // Primer-1 // Tie-1 (5 μm)/PPx (35 μm)

Sample 8: boPET (25 μm) // Primer-1 // Tie-2 (5 μm)/PPx (35 μm)

Sample 9: boPET (25 μm) // Primer-2 // Tie-1 (5 μm)/PPx (35 μm)

Sample 10: boPET (25 μm) // Primer-2 // Tie-2 (5 μm)/PPx (35 μm)

Samples Preparation (Samples 1-4 and 7-10)

The samples were prepared by co-extrusion coating as follows:

For each sample, the substrate film layer was unwound from the main roll, corona treated to a surface tension of 44 dyn/cm, primed with a coating thickness of 0.8 g/m² wet, and dried in a 4 m long oven at 110° C. and at a line speed of 80 m/min. The material for the Solvent Free Polymeric Film Layer (Tie-1 or Tie-2) was introduced in extruder A (64 mm diameter, length/diameter (L/D)=30), the material for the Sealant Layer was introduced in extruder B (89 mm diameter, L/D=30). For each extruder, the temperatures in ° C. were set for five (5) zones of equal length according to the following temperature profile:

| | | | | | |
|---|---|---|---|---|---|
| Extruder A: | 180 | 210 | 240 | 270 | 300 |
| Extruder B: | 200 | 230 | 260 | 290 | 315 |

The temperature of the adaptor, the connecting pipes, the feed-bloc was set up at 310° C. and the die temperature was set up at 300° C., on the side of the solvent free polymeric film layer, and at 315° C. on the side of the sealant layer. The die gap was 0.7 mm and the die width 800 mm. The air-gap was set at 15 cm. The pressure in the nip was 40 Kg/cm causing the rubber (80 Shore A) to deform over about 2 cm. The chill-roll temperature was 10° C.

Tests

Adhesion Strengths

The adhesion force was measured on 15 mm wide strips in a tensile tester manufactured by Zwick AG, Germany at a pulling angle of 1800 and a pulling speed of 100 mm/min.

The adhesion forces reported on Table I were measured on samples directly after production (Direct) and on samples previously soaked in water during one week (H₂O soak).

Heat-Seal Strengths

The multilayer films are cut in 15 mm wide strips. Two strips are sealed with the sealer layer film on sealer layer film in a heat sealer manufactured by Kopp (Germany) with two metallic and heated seal jaws 25 mm wide, 200 mm long. The sealing conditions used in the Example are: 0.3 MPa pressure applied on the seal area during 1 second, the temperature of the seal jaws being at 200° C.

The seal force is measured on 15 mm wide strips in a tensile tester manufactured by Zwick AG, Germany at a pulling angle of 180° and a pulling speed of 100 mm/min.

Retort

The multilayer films were cut into strips. Squared pouches of 10 cm×10 cm were prepared from these strips by sealing the sealant layer film on sealant layer film in a heat sealer manufactured by Kopp (Germany) with two metallic and heated seal jaws. The sealing conditions used in the Example were: 0.3 MPa pressure applied on the seal area during 1 second, the temperature of the seal jaws being at 200° C. The pouches, previously sealed on three sides were then filled with approximately 20 grams of Bumble Bee® solid white albacore tuna packed in oil. The fourth side of the pouches was then sealed at the same conditions described above.

The filled pouches were then sterilized at 0.13 MPa and 130° C. for thirty (30) minutes. For each sample it was then assessed if delamination (D), partial delamination (PD) or no delamination (ND) of the multilayer film structure took place.

The tests results are shown in Table I

TABLE I

| | Adhesion Strength | | Heat Seal | |
|---|---|---|---|---|
| | (N/15 mm) | | Strength | |
| Sample No. | Direct | H₂O soak | (N/15 mm) | Retort |
| Invention | | | | |
| 1 | 8.7 | 8.2 | 33.5 | PD |
| 2 | Inseparable | Inseparable | — | ND |
| 3 | 7.8 | 7.5 | — | PD |
| 4 | Inseparable | Inseparable | — | ND |
| Comp. | | | | |
| 7 | 3.7 | 3.6 | 28.0 | D |
| 8 | 3.4 | 3.0 | — | D |
| 9 | 3.9 | 3.8 | — | D |
| 10 | 4.0 | 3.9 | — | D |

Samples Preparation (Samples 5 and 6)

Sample 5 was prepared by extrusion lamination as follows: the Substrate Film Layer was unwound from the main roll, corona treated to a surface tension of 44 dyn/cm, with a coating thickness of 0.8 g/m² wet, and dried in a 4 m long oven at 110° C. and at a line speed of 100 m/min. The material for the Solvent Free Polymeric Film Layer (Tie-3) was introduced in extruder A (64 mm diameter, L/D=30).

The extruder temperatures in ° C. were set for five (5) zones of equal length according to the following temperature profile:

| | | | | |
|---|---|---|---|---|
| 190 | 220 | 250 | 280 | 310. |

The temperature of the adaptor, the connecting pipes, the feed-bloc and the die was set up at 310° C. The die gap was 0.7 mm and the die width 800 mm. The air-gap was set at 15 cm. The pressure in the nip was 40 Kg/cm causing the rubber (80 Shore A) to deform over about 2 cm. The chill-roll temperature was 18° C. The aluminum foil was unwound from the second roll and introduced in the nip at a line speed of 100 m/min.

Sample 6 was prepared as follows: the substrate film layer was unwound from the main roll and corona treated to a surface tension of 44 dyn/cm at a line speed of 100 m/min. The material for the Solvent Free Polymeric Film Layer (Tie-3) was introduced in extruder B (89 mm diameter, L/D=30). The extruder temperatures in ° C. were set for five (5) zones of equal length according to the following temperature profile:

| | | | | |
|---|---|---|---|---|
| 180 | 200 | 230 | 260 | 280. |

The temperature of the adaptor, the connecting pipes, the feed-bloc and the die was set up at 280° C. The die gap was 0.7 mm and the die width 800 mm. The air-gap was set at 15 cm. The pressure in the nip was 40 Kg/cm causing the rubber (80 Shore A) to deform over about 2 cm. The chill-roll temperature was 18° C. The aluminum foil was unwound from the second roll and introduced in the nip at a line speed of 100 m/min.

Tests

Adhesion Strengths:

The adhesion force was measured on 15 mm wide strips in a tensile tester manufactured by Zwick AG, Germany at a pulling angle of 180° and a pulling speed of 100 mm/min.

The adhesion forces reported in Table II were measured on samples previously heated in an oven during one minute at the given temperatures.

TABLE II

Adhesion Strength
(N/15 mm)

| Sample No. | 110° C. | 120° C. | 130° C. |
|---|---|---|---|
| 5 | 2.6 | Inseparable | Inseparable |
| 6 | 0.4 | Inseparable | Inseparable |

The results in the Tables clearly indicate that the multilayer film structures according to the present invention are superior in their adhesion (Tables I and II) and heat seal strengths (Table I). Furthermore, the multilayer film structures according to the present invention keep the desired properties unchanged even after undergoing retort treatments (Table I).

1. Multilayer film for flexible packaging comprising in the following sequence:
a) at least one substrate film layer comprising an axially oriented polyamide film; and
b) at least one solvent free polymeric film layer comprising a grafted polypropylene and extrusion coated on the substrate film layer of a).

2. The multilayer film of claim 1 further comprising at least one functional layer adjacent to the at least one solvent free polymeric film layer of b) on the opposite side of the substrate film layer of a).

3. The multilayer film of claim 2, wherein the at least one functional layer is a sealant layer comprising a polypropylene, the sealant layer being co-extrusion coated on the substrate film layer of a) with the at least one solvent free polymeric film layer of b).

4. The multilayer film of claim 2, wherein the at least one functional layer is a foil made essentially of aluminum which is extrusion laminated on the substrate film layer a) with the at least one solvent free polymeric film layer of b).

5. The multilayer film of claim 1 wherein the axially oriented polyamide is mono-axially oriented.

6. The multilayer film of claim 1 wherein the axially oriented polyamide is bi-axially oriented.

7. The multilayer film of claim 1 wherein the at least one substrate film layer has a thickness ranging from about 10 to about 40 μm.

8. The multilayer film of claim 1 wherein the at least one solvent free polymeric film layer has a melt flow index ranging from about 3 to about 50 dg/min, measured according to ASTM D1238 at 230° C. and 2.16 kg.

9. The multilayer film of claim 1 wherein the at least one solvent free polymeric film layer is grafted with maleic anhydride, the maleic anhydride being present in an amount ranging from about 0.1 to about 1.5% of the total weight of the at least one solvent free polymeric film layer.

10. The multilayer film of claim 1 wherein the at least one solvent free polymeric film layer has a thickness ranging from about 3 to about 50 μm.

11. The multilayer film of claim 1, further comprising a water borne extrusion primer layer between the at least one substrate film layer of a) and the at least one solvent free polymeric film layer of b).

12. The multilayer film of claim 11, wherein the water borne extrusion primer layer is based on poly (ethylene imine).

13. A flexible packaging having at least one component comprising a multilayer film as claimed in claim 1.

14. The flexible packaging of claim 13 wherein the at least one component is a retortable lid.

15. The flexible packaging of claim 13 which is entirely made with a material comprising the multilayer film as claimed in claim 1.
